(19) United States
(12) Patent Application Publication
(10) Pub. No.: US 2024/0101265 A1
(43) Pub. Date: Mar. 28, 2024

(54) FLEXIBLE METALLIC DRIVE SHAFT DIAPHRAGM HAVING ENHANCED DAMAGE TOLERANCE

(71) Applicant: Goodrich Corporation, Charlotte, NC (US)

(72) Inventors: Mark R. Gurvich, Middletown, CT (US); Joyel Schaefer, Earlville, NY (US); Michael J. King, Sauquoit, NY (US); Brayton Reed, New York Mills, NY (US)

(21) Appl. No.: 17/947,447

(22) Filed: Sep. 19, 2022

(51) Int. Cl. B64D 35/08; F16D 1/02; F16D 3/16

(52) U.S. Cl. CPC B64D 35/08; F16D 1/02; F16D 3/16

(57) ABSTRACT

A flexible diaphragm coupler includes a flange having a central support and a flange element extending radially outwardly from the central support. The flange element includes a rim portion having an axially facing surface. The axially facing surface includes a plurality of interlock elements. A diaphragm member is disposed between the first flange and the second flange. The diaphragm member includes a diaphragm element. The diaphragm element includes a central support element and a disc member extending radially outwardly from the central support element. The disc member includes a rim element having an axially facing surface portion including a plurality of interlock members that connect with the plurality of interlock elements.

### BACKGROUND

Exemplary embodiments pertain to the art of drive shafts and, more particularly, to a flexible metallic drive shaft diaphragm having enhanced damage tolerance.

In certain installations, multiple drive shafts are employed to connect an engine to a tail rotor in a rotary wing aircraft. The drives shafts are connected one to another by flexible diaphragm couplers. The flexible diaphragm couplers are formed from multiple metallic plates that are welded together. Each plate includes a central hub and an outer annular edge. The central hub of one plate may be joined to a central hub of an adjacent plate by and the outer annular edge of the adjacent plate may be joined to an outer annular edge of another adjacent plate.

In certain installations, the central hubs and annular plates were joined by mechanical fasteners. Overtime, stresses imposed by operation of the drive shaft would create fractures in the mechanical fasteners that lead to failure of the diaphragm. In other installations, the central hubs and annular edges were joined by welds. Over time, the welds experience wear due to stresses imposed by operation of the drive shaft. The wear, over time, may transform into a crack. Over time, and with continual exposure to operational stresses, the crack may propagate leading to failure of the diaphragm. Therefore, to avoid damage in such flexible diaphragm couplings, the welded joints require exceptional quality with associated additional costs and labor. Thus, designs of the flexible drive shaft diaphragms with enhanced damage tolerance or/and reduced quality requirements are needed.

### BRIEF DESCRIPTION

Disclosed, in accordance with a non-limiting example, is a flexible diaphragm coupler including a first flange having a first central support and a first flange element extending radially outwardly from the first central support. The first flange element includes a first rim portion having a first axially facing surface and a second axially facing surface. The second axially facing surface includes a first plurality of interlock elements. A second flange has a second central support axially selectively aligned with the first central support and a second flange element extending radially outwardly from the second central support. The second flange element includes a second rim portion having a first axially facing surface section and a second axially facing surface section. The first axially facing surface section includes a second plurality of interlock elements. A diaphragm member is disposed between the first flange and the second flange. The diaphragm member includes a first diaphragm element connected with a second diaphragm element. The first diaphragm element includes a first central support element and a first disc member extending radially outwardly from the first central support element and the second diaphragm element including a second central support element and a second disc member extending radially outwardly from the second central support element. The first disc member includes a first rim element having a first axially facing surface portion and a second axially facing surface portion. The first axially facing surface portion includes a plurality of interlock members that connect with the first plurality of interlock elements. The second disc member includes a second rim element having a third axially facing surface portion and a fourth axially facing surface portion. The fourth axially facing surface portion includes a second plurality of interlock members that connect with the second plurality of interlock elements.

Additionally, or alternatively, in this or other non-limiting examples, one of the first plurality of interlock elements and the first plurality of interlock members includes a first curvilinear profile and the other of the first plurality of interlock elements and the first plurality of interlock members includes a second curvilinear profile that matches with the first curvilinear profile.

Additionally, or alternatively, in this or other non-limiting examples, the first curvilinear profile comprises a first sinusoidal profile and the second curvilinear profile comprises a second matching sinusoidal profile.

Additionally, or alternatively, in this or other non-limiting examples, one of the first plurality of interlock elements and the first plurality of interlock members includes a first sawtooth profile and the other of the first plurality of interlock elements and the first plurality of interlock members includes a second sawtooth profile that matches with the first sawtooth profile.

Additionally, or alternatively, in this or other non-limiting examples, the first sawtooth profile includes a plurality of sawtooth elements spaced one from another by a first linear section and the second sawtooth profile includes a matching plurality of sawtooth members spaced one from another by a second linear section.

Additionally, or alternatively, in this or other non-limiting examples, the first linear section includes a recess receptive of one of the pluralities of sawtooth members.

Additionally, or alternatively, in this or other non-limiting examples, the plurality of sawtooth elements includes a first trapezoidal shape. and the plurality of sawtooth members includes a second trapezoidal shape.

Additionally, or alternatively, in this or other non-limiting examples, one of the first plurality of interlock elements and the first plurality of interlock members includes a first semi-circular profile and the other of the first plurality of interlock elements and the first plurality of interlock members includes a second semi-circular profile that align with the first circular profile to form a plurality of circular openings.

Additionally, or alternatively, in this or other non-limiting examples, a cylindrical insert is arranged in each of the circular openings and welded to both the first and the second pluralities of the interlock elements.

Additionally, or alternatively, in this or other non-limiting examples, the second axially facing surface is welded to the first axially facing surface portion.

An aircraft, in accordance with a non-limiting example, includes a fuselage, an engine arranged in the fuselage, and a drive shaft connected to the engine. The drive shaft includes at first drive shaft section connected to a second drive shaft section by a flexible diaphragm coupler. The flexible diaphragm coupler includes a first flange having a first central support and a first flange element extending radially outwardly from the first central support. The first flange element includes a first rim portion having a first axially facing surface and a second axially facing surface. The second axially facing surface includes a first plurality of interlock elements. A second flange has a second central support axially selectively aligned with the first central support and a second flange element extending radially outwardly from the second central support. The second flange element includes a second rim portion having a first axially facing surface section and a second axially facing surface section. The first axially facing surface section includes a second plurality of interlock elements. A diaphragm member is disposed between the first flange and the second flange. The diaphragm member includes a first diaphragm element connected with a second diaphragm element. The first diaphragm element includes a first central support element and a first disc member extending radially outwardly from the first central support element and the second diaphragm element including a second central support element and a second disc member extending radially outwardly from the second central support element. The first disc member includes a first rim element having a first axially facing surface portion and a second axially facing surface portion. The first axially facing surface portion includes a plurality of interlock members that connect with the first plurality of interlock elements. The second disc member includes a second rim element having a third axially facing surface portion and a fourth axially facing surface portion. The fourth axially facing surface portion includes a second plurality of interlock members that connect with the second plurality of interlock elements.

Additionally, or alternatively, in this or other non-limiting examples, one of the first plurality of interlock elements and the first plurality of interlock members includes a first curvilinear profile and the other of the first plurality of interlock elements and the first plurality of interlock members includes a second curvilinear profile that matches with the first curvilinear profile.

Additionally, or alternatively, in this or other non-limiting examples, the first curvilinear profile comprises a first sinusoidal profile and the second curvilinear profile comprises a second matching sinusoidal profile.

Additionally, or alternatively, in this or other non-limiting examples, one of the first plurality of interlock elements and the first plurality of interlock members includes a first sawtooth profile and the other of the first plurality of interlock elements and the first plurality of interlock members includes a second sawtooth profile that matches with the first sawtooth profile.

Additionally, or alternatively, in this or other non-limiting examples, the first sawtooth profile includes a plurality of sawtooth elements spaced one from another by a first linear section and the second sawtooth profile includes a matching plurality of sawtooth members spaced one from another by a second linear section.

Additionally, or alternatively, in this or other non-limiting examples, the first linear section includes a recess receptive of one of the pluralities of sawtooth members.

Additionally, or alternatively, in this or other non-limiting examples, the plurality of sawtooth elements includes a first trapezoidal shape. and the plurality of sawtooth members includes a second trapezoidal shape.

Additionally, or alternatively, in this or other non-limiting examples, one of the first plurality of interlock elements and the first plurality of interlock members includes a first semi-circular profile and the other of the first plurality of interlock elements and the first plurality of interlock members includes a second semi-circular profile that align with the first circular profile to form a plurality of circular openings.

Additionally, or alternatively, in this or other non-limiting examples, a cylindrical insert is arranged in each of the circular openings and welded to both the first and the second pluralities of the interlock elements.

Additionally, or alternatively, in this or other non-limiting examples, the second axially facing surface is welded to the first axially facing surface portion.

### BRIEF DESCRIPTION OF THE DRAWINGS

The following descriptions should not be considered limiting in any way. With reference to the accompanying drawings, like elements are numbered alike:

FIG. 1 is a perspective glass view of a rotary wing aircraft including drive shafts joined by flexible diaphragm couplers having enhanced damage tolerance, in accordance with a non-limiting example;

FIG. 2 is a perspective side view of the flexible diaphragm coupler including a first welded connection and a second welded connection, in accordance with a non-limiting example;

FIG. 3 is a cross-sectional view of the flexible diaphragm coupler including a first welded connection and a second welded connection disposed radially outwardly of the first welded connection, in accordance with a non-limiting example;

FIG. 4 is a disassembled view of the first welded connection, in accordance with a non-limiting example;

FIG. 5 is an elevational view of the first welded connection of FIG. 4 after welding, in accordance with a non-limiting example;

FIG. 6 is a disassembled view of the first welded connection, in accordance with another non-limiting example;

FIG. 7 is an elevational view of the first welded connection of FIG. 6 after welding, in accordance with another non-limiting example;

FIG. 8 is a disassembled view of the first welded connection, in accordance with still yet another non-limiting example;

FIG. 9 is an elevational view of the first welded connection of FIG. 8 after welding, in accordance with still yet another non-limiting example;

FIG. 10 is a disassembled view of the first welded connection, in accordance with yet still another non-limiting example;

FIG. 11 is an elevational view of the first welded connection of FIG. 10 after welding, in accordance with yet still another non-limiting example;

FIG. 12 is a disassembled view of the first welded connection, in accordance with a further non-limiting example; and

FIG. 13 is an elevational view of the first welded connection of FIG. 12 after welding, in accordance with a further non-limiting example.

### DETAILED DESCRIPTION

A detailed description of one or more embodiments of the disclosed apparatus and method are presented herein by way of exemplification and not limitation with reference to the Figures.

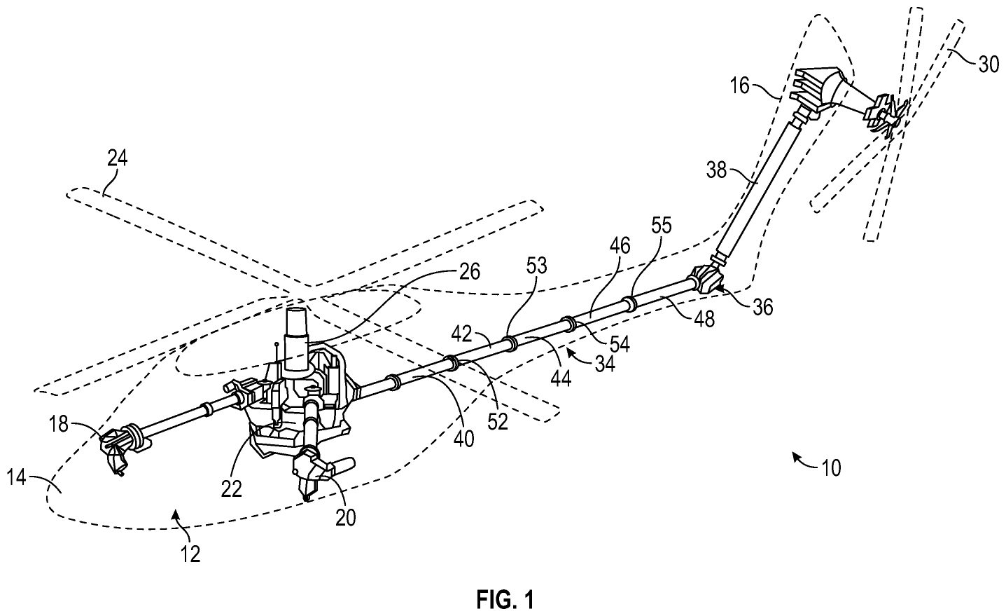

As shown in FIG. 1, a rotary wing aircraft 10, in accordance with a non-limiting example, includes a fuselage 12 including a main cabin/cockpit 14 and a tail 16. Aircraft 10 includes a first engine 18 and a second engine 20 connected to a gearbox 22. A main rotor 24 is connected to gearbox 22 through a main rotor shaft 26. A tail rotor 30 supported on tail 16 is also connected to gearbox 22. That is a tail rotor shaft 34 extends from gearbox 22 to an intermediate gearbox 36 located in tail 16 and a pylon drive shaft 38 extends from intermediate gearbox 36 to tail rotor 30.

A representative tail rotor shaft 34 is formed from a plurality of interconnected drive shaft sections including first drive shaft section 40, a second drive shaft section 42, a third drive shaft section 44, a fourth drive shaft section 46 and a fifth drive shaft section 48. First drive shaft section 40 is connected to gearbox 22 and fifth drive shaft section 48 is connected to intermediate gearbox 36. The drive shaft sections are joined by a plurality of flexible diaphragm coupler couplers. In a non-limiting example, a first flexible diaphragm coupler 52 connected first drive shaft section 40 with second drive shaft section 42, a second flexible diaphragm coupler 53 connects second drive shaft section 42 with third drive shaft section 44, a third flexible diaphragm coupler 54 connects third drive shaft section 44 with fourth drive shaft section 46, and a fourth flexible diaphragm coupler 55 connects fourth drive shaft section 46 with fifth drive shaft section 48.

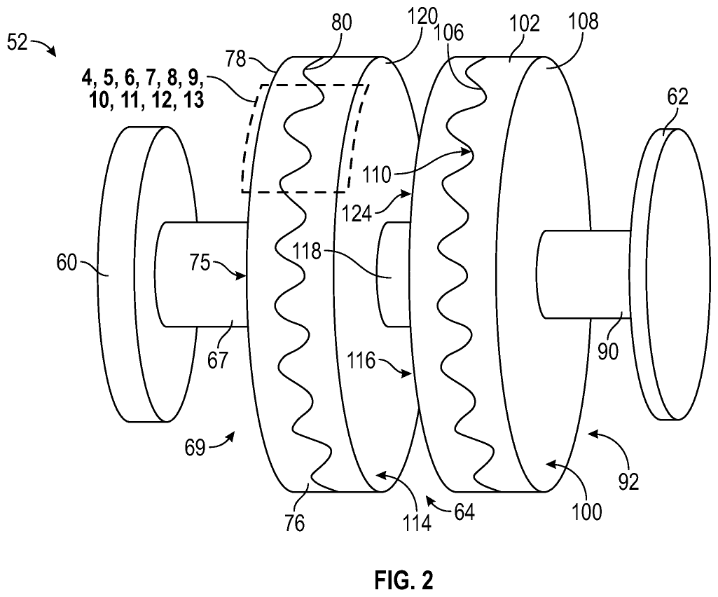

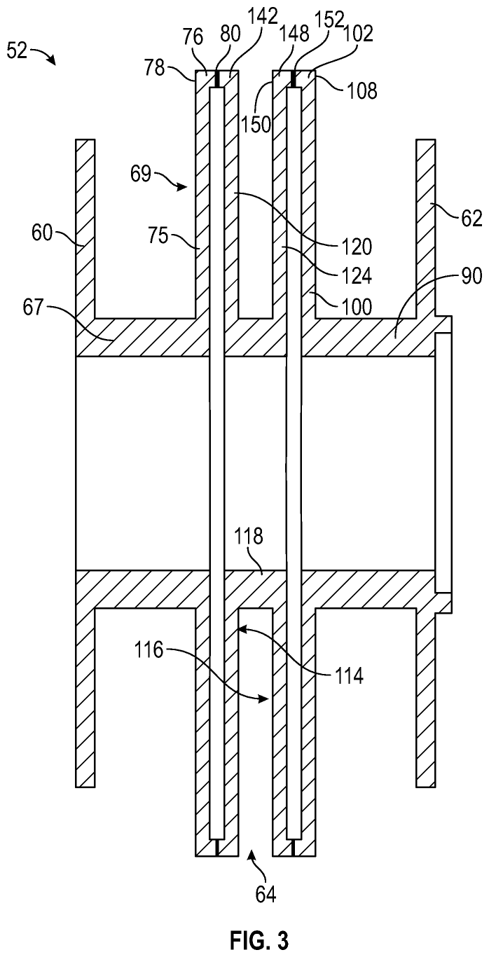

Reference will now follow to FIGS. 2 and 3 in describing first flexible diaphragm coupler 52 with an understanding that second, third, and fourth flexible diaphragm couplers 53-55 include corresponding structure. First flexible diaphragm coupler 52 includes a first flange 60 connected to a second flange 62 through a diaphragm member 64. First flange 60 is connected to first drive shaft section 40 and second flange 62 is coupled to second drive shaft section 42. First flexible diaphragm coupler 52 is designed to accommodate out of axis movement of tail rotor shaft 34. In addition, connections between first flange 60, second flange 62, and diaphragm member 64 are engineered to possess enhanced damage tolerance as will be detailed herein.

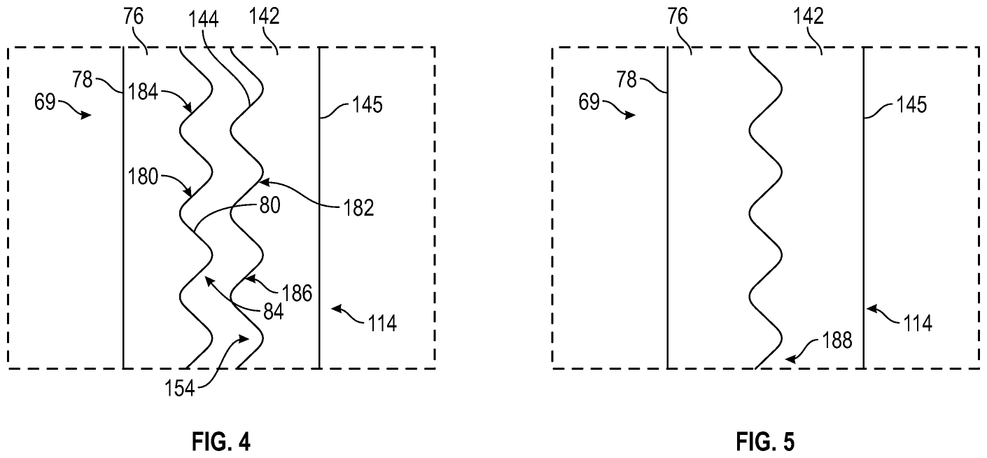

In a non-limiting example, first flange 60 includes a first central support 67 and a first flange element 69. First flange element 69 includes a first disc 75 that extends radially outwardly from central support 67. First disc 75 includes a first rim portion 76 arranged at a radially outermost edge (not separately labeled) of first disc 75. First rim portion 76 includes a first axially facing surface 78 and a second axially facing surface 80. In a non-limiting example, second axially facing surface 80 includes a plurality of interlock elements 84 (FIG. 4) which, as will be detailed more fully herein, connect with diaphragm member 64.

Second flange 62 includes a second central support 90 and a second flange element 92 that is connected to second central support 90. Second flange element 92 includes a second disc 100 that extends radially outwardly from central support 90. Second disc 100 includes a second rim portion 102 arranged at a radially outermost edge (not separately labeled) of second disc 100. Second rim portion 102 includes a first axially facing surface section 106 and a second axially facing surface section 108. In a non-limiting example, first axially facing surface section 106 includes a second plurality of interlock elements (not separately labeled) which, as will be detailed more fully herein, connect with diaphragm member 64.

In a non-limiting example, diaphragm member 64 includes a first diaphragm element 114 connected to a second diaphragm element 116 through a central support element 118. As will be detailed herein, first diaphragm element 114 is connected to first rim portion 76 and second diaphragm element 116 is connected to second rim portion 102. First diaphragm element 114 includes a first disc member 120 that projects radially outwardly from central support element 118. Second diaphragm element 116 includes a second disc member 124 that projects radially outwardly of central support element 118.

As shown in FIG. 3, in a non-limiting example, first disc member 120 includes a first rim element 142 arranged at a radially outermost end thereof. First rim element 142 includes a first axially facing surface portion 144 and a second axially facing surface portion 145 (FIG. 4). Second disc member 124 includes a second rim element 148 arranged at a radially outermost end thereof. Second rim element 148 includes a third axially facing surface portion 150 and a fourth axially facing surface portion 152. In a non-limiting example, first axially facing surface portion 144 includes a first plurality of interlock members 154. Fourth axially facing surface portion 152 includes a second plurality of interlock members (not separately labeled).

In a non-limiting example, first plurality of interlock members 154 engage with first plurality of interlock element 84 on second axially facing surface 80 of first rim portion 76. Similarly, the second plurality of interlock member engage with second plurality of interlock elements arranged on second axially facing surface section 108 of second rim portion 102. Once engaged, first rim portion 76 may be welded to first rim element 142 and second rim portion 102 may be welded to second rim element 148. As will be discussed herein, engagement of first plurality of interlock elements 84 and first plurality of interlock member 154 creates a non-linear annular interface that resists crack propagation in the circumferential direction. A similar non-linear interface if formed between second rim portion 102 and second rim element 148.

Reference will now follow to FIGS. 4 and 5 in describing the engagement of first plurality of interlock elements 84 and first plurality of interlock member 154 with an understanding that second rim portion 102 and second rim element 148 are engaged in a similar manner. Further, other component interfaces, may include similar features.

In accordance with a non-limiting example, first plurality of interlock elements 84 arranged on second axially facing surface 80 of first rim portion 76 include a first curvilinear profile 180 and first plurality of interlock members 154 arranged in first axially facing surface portion 144 of first rim element 142 includes a second curvilinear profile 182 that matches with first curvilinear profile 180. In a non-limiting example, first curvilinear profile 180 takes the form of a first sinusoidal profile 184 and second curvilinear profile 182 takes the form of a second sinusoidal profile 186. With this arrangement, when first rim portion 76 and first rim element 142 are brought together, second axially facing surface 80 and first axially facing surface portion 144 form a sinusoidal interface 188 (FIG. 5) that may be welded to join first flange 60 with first diaphragm element 114. Note that in other embodiments, curvilinear profile 180 can differ from a pure sinusoidal shape and can have similar dependence with periodic smooth undulations defined by uniformly or non-uniformly distributed curvatures.

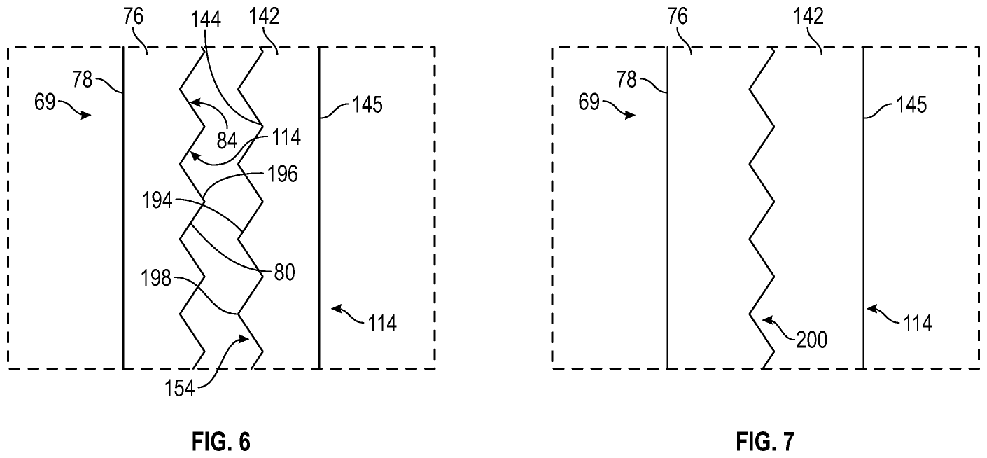

In accordance with another non-limiting example shown in FIGS. 6 and 7, first plurality of interlock elements 84 arranged on second axially facing surface 80 of first rim portion 76 include a first sawtooth profile 192 and first plurality of interlock members 154 arranged in first axially facing surface portion 144 of first rim element 142 includes a second sawtooth profile 194 that matches with first sawtooth profile 192. In a non-limiting example, first sawtooth profile 192 includes a first plurality of sawtooth elements 196 and second sawtooth profile 194 includes a second plurality of sawtooth elements 198. With this arrangement, when first rim portion 76 and first rim element 142 are brought together, second axially facing surface 80 and first axially facing surface portion 144 form a sawtooth interface 200 (FIG. 7) that may be welded to join first flange 60 with first diaphragm element 114.

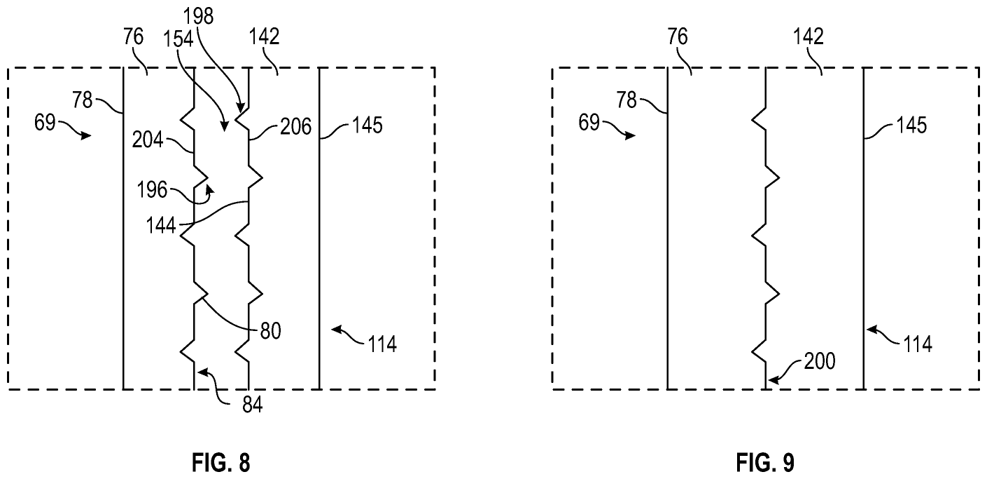

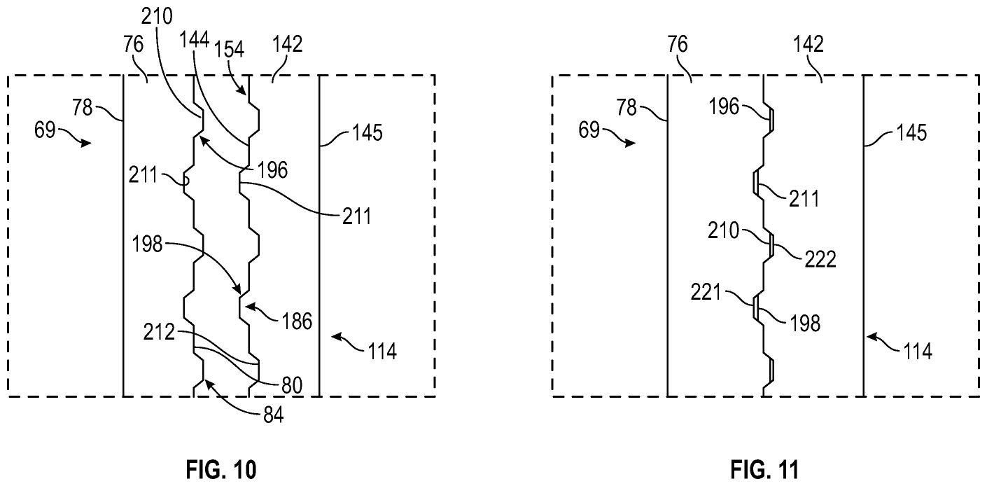

In accordance with a non-limiting example shown in FIGS. 8 and 9, first plurality of sawtooth elements 196 are spaced one from another by a first linear section 204 and each of the second plurality of sawtooth elements 198 are spaced one from another by a second linear section 206. As shown in FIGS. 10 and 11, each of the first plurality of sawtooth elements 196 includes a first trapezoidal profile 210 and each of the second plurality of sawtooth elements 198 includes a second trapezoidal profile 211.

In a non-limiting example shown in FIGS. 10 and 11, a first plurality of recesses such as shown at 212 are receptive of corresponding ones of the second plurality of sawtooth elements 198. A second plurality of recesses 214 is receptive of corresponding ones of the first plurality of sawtooth elements 196. With this arrangement, when first rim portion 76 and first rim element 142 are brought together, a first plurality of voids 221 exist at each of the first plurality of sawtooth elements 196 and a second plurality of voids 222 exist at each of the second plurality of sawtooth elements 198.

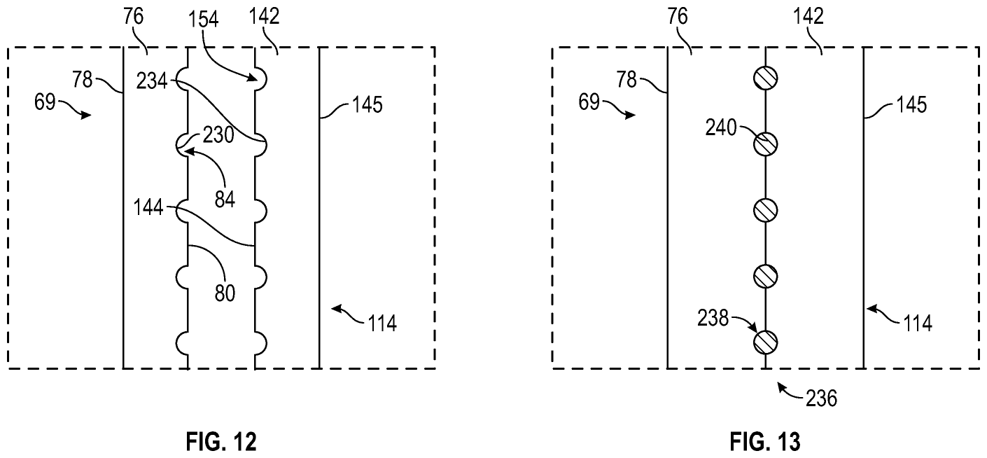

In accordance with another non-limiting example shown in FIGS. 12 and 13, first plurality of interlock elements 84 arranged on second axially facing surface 80 of first rim portion 76 include a first semi-circular profile 230 and first plurality of interlock members 154 arranged in first axially facing surface portion 144 of first rim element 142 includes a second semicircular profile 234 that align with the first plurality of interlock elements 84 to form a plurality of circular openings 238 that extend about an interface 236 of first rim portion 76 and first rim element 142. In accordance with a non-limiting example, a cylindrical insert 240 is arranged in each of the circular openings 238 and a weld bead is formed about interface 236.

At this point, it should be understood that an irregular seam or interface established by joining and welding together first rim portion 76 with first rim element 142 inhibits propagation of cracks that may develop as a result of operations stresses. It should also be appreciated that while the irregular interface is described in terms of joining and welding together first rim portion 76 with first rim element 142 each component interface, e.g., first flange 60 and first flange element 69, second flange 62 and second flange element 92, as well as second rim portion 102 and second rim element 148 may include similar features. Further, it should be appreciated that the number of components being joined as described herein may vary.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A flexible diaphragm coupler comprising:
a first flange having a first central support and a first flange element extending radially outwardly from the first central support, the first flange element including a first rim portion having a first axially facing surface and a second axially facing surface, the second axially facing surface including a first plurality of interlock elements;
a second flange having a second central support axially selectively aligned with the first central support and a second flange element extending radially outwardly from the second central support, the second flange element including a second rim portion having a first axially facing surface section and a second axially facing surface section, the first axially facing surface section including a second plurality of interlock elements; and
a diaphragm member disposed between the first flange and the second flange, the diaphragm member including a first diaphragm element connected with a second diaphragm element, the first diaphragm element including a first central support element and a first disc member extending radially outwardly from the first central support element and the second diaphragm element including a second central support element and a second disc member extending radially outwardly from the second central support element,
wherein the first disc member includes a first rim element having a first axially facing surface portion and a second axially facing surface portion, the first axially facing surface portion including a plurality of interlock members that connect with the first plurality of interlock elements, and
wherein the second disc member includes a second rim element having a third axially facing surface portion and a fourth axially facing surface portion, the fourth axially facing surface portion including a second plurality of interlock members that connect with the second plurality of interlock elements.

2. The flexible diaphragm coupler according to claim 1, wherein one of the first plurality of interlock elements and the first plurality of interlock members includes a first curvilinear profile and the other of the first plurality of interlock elements and the first plurality of interlock members includes a second curvilinear profile that matches with the first curvilinear profile.

3. The flexible diaphragm coupler according to claim 2, wherein the first curvilinear profile comprises a first sinusoidal profile and the second curvilinear profile comprises a second matching sinusoidal profile.

4. The flexible diaphragm coupler according to claim 1, wherein one of the first plurality of interlock elements and the first plurality of interlock members includes a first sawtooth profile and the other of the first plurality of interlock elements and the first plurality of interlock members includes a second sawtooth profile that matches with the first sawtooth profile.

5. The flexible diaphragm coupler according to claim 4, wherein the first sawtooth profile includes a plurality of sawtooth elements spaced one from another by a first linear section and the second sawtooth profile includes a matching plurality of sawtooth members spaced one from another by a second linear section.

6. The flexible diaphragm coupler according to claim 5, wherein the first linear section includes a recess receptive of one of the pluralities of sawtooth members.

7. The flexible diaphragm coupler according to claim 6, wherein the plurality of sawtooth elements includes a first trapezoidal shape and the plurality of sawtooth members includes a second trapezoidal shape.

8. The flexible diaphragm coupler according to claim 1, wherein one of the first plurality of interlock elements and the first plurality of interlock members includes a first semi-circular profile and the other of the first plurality of interlock elements and the first plurality of interlock members includes a second semi-circular profile that align with the first semi-circular profile to form a plurality of circular openings.

9. The flexible diaphragm coupler according to claim 8, further comprising: a cylindrical insert arranged in each of the plurality of circular openings and welded to both the first and the second pluralities of the interlock elements.

10. The flexible diaphragm coupler according to claim 1, wherein the second axially facing surface is welded to the first axially facing surface portion.

11. An aircraft comprising:
a fuselage;
an engine arranged in the fuselage;
a drive shaft connected to the engine, the drive shaft including at first drive shaft section connected to a second drive shaft section by a flexible diaphragm coupler comprising:
a first flange having a first central support and a first flange element extending radially outwardly from the first central support, the first flange element including a first rim portion having a first axially facing surface and a second axially facing surface, the second axially facing surface including a first plurality of interlock elements;
a second flange having a second central support axially selectively aligned with the first central support and a second flange element extending radially outwardly from the second central support, the second flange element including a second rim portion having a first axially facing surface section and a second axially facing surface section, the first axially facing surface section including a second plurality of interlock elements; and
a diaphragm member disposed between the first flange and the second flange, the diaphragm member including a first diaphragm element connected with a second diaphragm element, the first diaphragm element including a first central support element and a first disc member extending radially outwardly from the first central support element and the second diaphragm element including a second central support element and a second disc member extending radially outwardly from the second central support element,
wherein the first disc member includes a first rim element having a first axially facing surface portion and a second axially facing surface portion, the first axially facing surface portion including a plurality of interlock members that connect with the first plurality of interlock elements, and
wherein the second disc member includes a second rim element having a third axially facing surface portion and a fourth axially facing surface portion, the fourth axially facing surface portion including a second plurality of interlock members that connect with the second plurality of interlock elements.

12. The aircraft according to claim 11, wherein one of the first plurality of interlock elements and the first plurality of interlock members includes a first curvilinear profile and the other of the first plurality of interlock elements and the first plurality of interlock members includes a second curvilinear profile that matches with the first curvilinear profile.

13. The aircraft according to claim 12, wherein the first curvilinear profile comprises a first sinusoidal profile and the second curvilinear profile comprises a second sinusoidal profile.

14. The aircraft according to claim 11, wherein one of the first plurality of interlock elements and the first plurality of interlock members includes a first sawtooth profile and the other of the first plurality of interlock elements and the first plurality of interlock members includes a second sawtooth profile that matches with the first sawtooth profile.

15. The aircraft according to claim 14, wherein the first sawtooth profile includes a plurality of sawtooth elements spaced one from another by a first linear section and the second sawtooth profile includes a plurality of sawtooth members spaced one from another by a second linear section.

16. The aircraft according to claim 15, wherein the first linear section includes a recess receptive of one of the pluralities of sawtooth members.

17. The aircraft according to claim 16, wherein the plurality of sawtooth elements includes a first trapezoidal shape, and the plurality of sawtooth members includes a second trapezoidal shape.

18. The aircraft according to claim 11, wherein one of the first plurality of interlock elements and the first plurality of interlock members includes a first semi-circular profile and the other of the first plurality of interlock elements and the first plurality of interlock members includes a second semi-circular profile that align with the first semi-circular profile to form a plurality of circular openings.

19. The aircraft according to claim 18, further comprising: a cylindrical insert arranged in each of the plurality of circular openings and welded to both the first and the second pluralities of the interlock elements.

20. The aircraft according to claim 11, wherein the second axially facing surface is welded to the first axially facing surface portion.
